(19) United States
(12) Patent Application Publication
(10) Pub. No.: US 2017/0089222 A1
(43) Pub. Date: Mar. 30, 2017

(54) ORC SYSTEM POST ENGINE SHUTDOWN PRESSURE MANAGEMENT

(71) Applicant: EATON CORPORATION, Cleveland, OH (US)

(72) Inventors: Bradley Karl WRIGHT, JR., Livonia, MI (US); Matthew James FORTINI, Livonia, MI (US)

(73) Assignee: EATON CORPORATION, Cleveland, OH (US)

(21) Appl. No.: 15/126,057

(22) PCT Filed: Mar. 13, 2015
(86) PCT No.: PCT/US15/20447

§ 371 Date: Sep. 14, 2016

Related U.S. Application Data
(60) Provisional application No. 61/953,369, filed on Mar. 14, 2014.

(51) Int. Cl. F01K 23/06; F01K 3/14; F02M 26/28; F01K 23/10

(52) U.S. Cl. CPC F01K 23/065; F01K 23/10; F01K 3/14; F02M 26/28

(57) ABSTRACT

The present disclosure relates to a Rankine cycle system including a Rankine cycle circuit in which working fluid is cycled through a condensing zone, a heating zone, and a mechanical energy extraction zone. The system also includes a hydraulic accumulator for storing pressurized working fluid from the Rankine cycle circuit when a pressure of the working fluid within the Rankine cycle circuit is above a first pressure level, and for releasing pressurized working fluid to the Rankine cycle circuit when the working fluid within the Rankine cycle circuit is below a second pressure level.

### RELATED APPLICATIONS

This application is being filed on Mar. 13, 2015, as a PCT International Patent application and claims priority to U.S. Patent Application Ser. No. 61/953,369 filed on Mar. 14, 2014, the disclosure of which is incorporated herein by reference in its entirety.

### TECHNICAL FIELD

The present disclosure relates to systems for recovering waste heat. More particularly, the present disclosure relates to organic Rankine cycle systems.

### BACKGROUND

The Rankine cycle or Organic Rankine Cycle (ORC) is a power generation cycle that converts thermal energy to mechanical work. The Rankine cycle is typically used in heat engines, and accomplishes the above conversion by bringing a working substance from a higher temperature state to a lower temperature state. The classical Rankine cycle is the fundamental thermodynamic process underlying the operation of a steam engine.

The Rankine cycle typically employs individual subsystems, such as a condenser, a fluid pump, a heat exchanger such as a boiler, and an expander turbine. The pump is frequently used to pressurize the working fluid that is received from the condenser as a liquid rather than a gas. The pressurized liquid from the pump is heated at the heat exchanger and used to drive the expander turbine so as to convert thermal energy into mechanical work. Upon exiting the expander turbine, the working fluid returns to the condenser where any remaining vapor is condensed. Thereafter, the condensed working fluid returns to the pump and the cycle is repeated.

A variation of the classical Rankine cycle is the organic Rankine cycle (ORC), which is named for its use of an organic, high molecular mass fluid, with a liquid-vapor phase change, or boiling point, occurring at a lower temperature than the water-steam phase change. As such, in place of water and steam of the classical Rankine cycle, the working fluid in the ORC may be a solvent, such as n-pentane or toluene. The ORC working fluid allows Rankine cycle heat recovery from lower temperature sources such as biomass combustion, industrial waste heat, geothermal heat, solar ponds, etc. The low-temperature heat may then be converted into useful work, which may in turn be converted into electricity.

Further development in such Rankine cycle systems is desired.

### SUMMARY

When a sealed Rankine cycle system reaches low temperature (e.g., after a system shut-down and cold soak), the working fluid may condense thereby drawing an unintended vacuum on the system. The vacuum may create a potential for leakage and can cause premature seal and fitting failures. Aspects of the present disclosure relate to methods and structures for maintaining positive pressure in a Rankine cycle system even under low temperature conditions. In one example, a working fluid accumulator is used to prevent the system from experiencing vacuum conditions at low temperatures. In one example, the Rankine cycle system is an organic Rankine cycle system that generates mechanical work from waste heat generated by a prime mover, such as an internal combustion engine (e.g., a spark ignition gasoline engine, a compression ignition diesel engine, a hydrogen internal combustion engine, etc.) or a fuel cell. In certain examples, the prime mover is used to power a vehicle, and the Rankine cycle system coverts waste heat into mechanical energy that can be used to enhance the operating efficiency of the prime mover or to power other active components of the vehicle.

In one example, a method for managing a working fluid pressure condition in a Rankine cycle system associated with a power plant in a shutdown condition is disclosed. One step of the method can include providing an accumulator in selective fluid communication with the Rankine cycle system while another step can include providing a control valve to isolate the accumulator from the Rankine cycle system working fluid. Additional steps can include storing pressurized working fluid in the accumulator while the power plant is in an operative state by placing the control valve in an open condition and isolating the accumulator from the Rankine cycle system by closing the control valve. One step of the method may include opening the control valve to place the accumulator in fluid communication with the Rankine cycle system by opening the control valve when the prime mover is in a shutdown condition and when a minimum threshold condition is reached to minimize or prevent a vacuum pressure condition from developing in the Rankine cycle circuit. Examples of a minimum threshold condition are the working fluid temperature and the ambient outdoor air temperature. A variety of additional aspects will be set forth in the description that follows. These aspects can relate to individual features and to combinations of features. It is to be understood that both the foregoing general description and the following detailed description are exemplary and explanatory only and are not restrictive of the broad concepts upon which the embodiments disclosed herein are based.

### BRIEF DESCRIPTION OF THE DRAWINGS

FIG. 1 is a schematic depiction of a system employing a Rankine cycle for generating useful work and having features that are examples of inventive aspects in accordance with the principles of the present disclosure;

FIG. 2 is a diagram depicting the Rankine cycle employed by the system shown in FIG. 1;

FIG. 3 is a cross-sectional view of a Roots-style expander suitable for use in extracting mechanical energy from the system of FIG. 1;

FIG. 4 is a schematic depiction of the Roots-style expander of FIG. 3;

FIG. 5 is a cross-sectional view showing timing gears of the Roots-style expander of FIG. 3; and

FIG. 6 schematically depicts a vehicle including a Rankine cycle system in accordance with the principles of the present disclosure.

### DETAILED DESCRIPTION

The present disclosure relates generally to a Rankine cycle system 100 (e.g., an organic Rankine cycle system) that utilizes heat from a heat source to generate useful work. In one example, the heat source is waste heat from a device such as a prime mover (e.g., an internal combustion engine such as a diesel engine or spark ignition engine, a fuel cell, etc.). In one example, a mechanical device such as a rotary expander is used to extract mechanical energy from the Rankine cycle system. In one example, the Rankine cycle system includes a closed Rankine cycle circuit, which is sealed to prevent working fluid from exiting the circuit and to prevent exterior contaminants from contaminating or otherwise mixing with the working fluid. In certain examples, when the Rankine cycle system is shut down, decreasing temperatures within the circuit may cause the working fluid to condense and draw a vacuum on the system.

The Rankine cycle operation can be associated with the operation of the prime mover such that shutdown of the prime mover results in a corresponding shutdown of the ORC system 100. Where the prime mover is an internal combustion engine, the working fluid temperature of the OCR system 100 can reach near 300° C. during operation, and can fall to the ambient air temperature surrounding the engine when the engine is shut off. As such, the working fluid temperature can reach −40° C. and below in cold climates when the engine is shut off. The resulting vacuum caused by the wide temperature difference between operating and shut off conditions may exert significant force on system seals and can create the potential for leakage, contamination, and premature seal failure.

To manage and offset the vacuum created during system shut down, the Rankine cycle system can include a pressurized accumulator configured to release a stored volume of working fluid/pressure during certain conditions (e.g., during shutdown, at a predetermined pressure, at a predetermined temperature, and/or a combination thereof, etc.) to offset the possibility of negative pressure being generated within the system. Suitable types of accumulators for use with the ORC system 100 are diaphragm-type accumulators, piston-type accumulators, bladder-type accumulators, and tank-type accumulators that do not have an interior barrier.

In certain examples, a control valve can be used to selectively segregate/isolate the accumulator from the Rankine cycle circuit. When the Rankine cycle system is operating normally, the control valve can be opened to allow the accumulator to be pressurized. In one example, the accumulator can be positioned at the high pressure side of a hydraulic pump used to move the working fluid through the circuit. Once the accumulator has been fully pressurized (as measured by sensor 164 or by another temperature sensor associated with the accumulator 120), the control valve can be closed to block fluid communication between the accumulator and the Rankine cycle circuit. During certain operating conditions where temperatures decrease and pressure within the main circuit decreases (e.g., during system shutdown), the control valve can be opened to allow pressure/working fluid from the accumulator to be used to maintain positive pressure within the circuit. In certain examples, the system can include various temperature sensors (e.g. a thermocouple) and pressure sensors for measuring the conditions at various locations within the circuit and a controller that interfaces with the sensors, the control valve, the pump, and other components within the system.

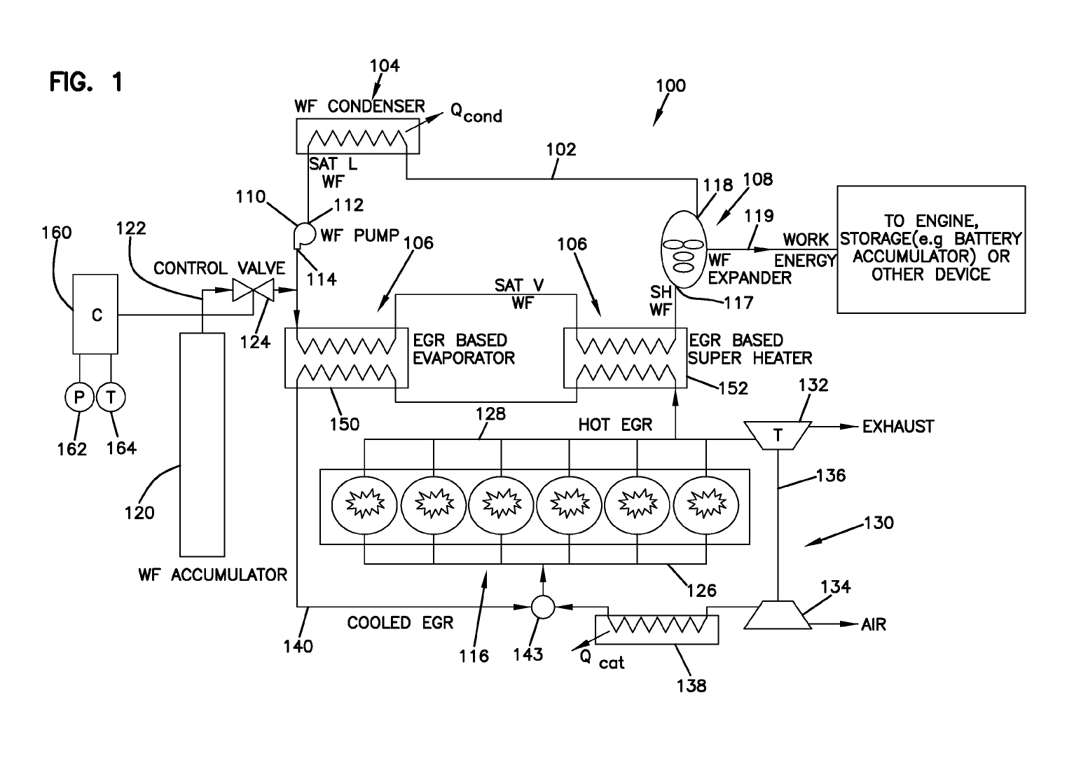

FIG. 1 illustrates an organic Rankine cycle system 100 in accordance with the principles of the present disclosure. The organic Rankine cycle system 100 is configured to convert heat energy from a heat source such as an engine 116 into mechanical energy. The organic Rankine cycle system 100 is configured to cycle a working fluid (e.g., a solvent such as ethanol, n-pentane, toluene or other solvents) repeatedly through a closed-loop organic Rankine cycle. As depicted at FIG. 1, the organic Rankine cycle system 100 includes a Rankine cycle circuit 102 having a condensing zone 104, a heating zone 106, and a mechanical energy extracting zone 108. A hydraulic pump 110 is used to move the working fluid through the Rankine cycle circuit 102. The pump 110 includes a low pressure side 112 in fluid communication with the condensing zone 104 and a high pressure side 114 in fluid communication with the heating zone 106. The mechanical energy extracting zone 108 has an inlet side 117 in fluid communication with the heating zone 106 and an outlet side 118 in fluid communication with the condensing zone 104. The organic Rankine cycle system 100 further includes a working fluid accumulator 120 used to maintain positive pressure within the Rankine cycle circuit 102. A flow line 122 is provided for placing the working fluid accumulator 120 in fluid communication with the high pressure side 114 of the pump 110. A control valve 124 can be provided for selectively opening and closing the flow line 122. The control valve 124 can be integral with an assembly including the accumulator 120 or can be provided separately and connected to the accumulator 124 via piping (e.g. line 122).

During normal operating conditions of the organic Rankine cycle system 100, the control valve 124 can be opened, thereby allowing pressurized working fluid from the high pressure side 114 of the pump 110 to flow through the flow line 122 into the working fluid accumulator 120 to charge the working fluid accumulator 120 with pressurized working fluid. When the working fluid accumulator 12.0 is charged, the control valve 124 can be closed to close the flow line 122 and break fluid communication between the accumulator 120 and the Rankine cycle circuit 102. As the term is used herein, the accumulator 120 is “charged” when the accumulator has at least sufficient working fluid to maintain a positive pressure in the circuit 102 during shutdown. During a low temperature and/or pressure condition within the Rankine cycle circuit 102 (e.g., during system shutdown when operation of the pump 110 has been terminated), the control valve 124 call be opened to place the working fluid accumulator 120 in fluid communication with the Rankine cycle circuit 102. The pressurized working fluid from the working fluid accumulator 120 can be used to maintain positive pressure or minimize a vacuum pressure within the Rankine cycle circuit 102.

The engine 116 is depicted in FIG. 1 as a diesel engine having an air intake manifold 126 and an exhaust manifold 128. A turbo charger 130 is used to increase the pressure of the intake air provided to the air intake manifold 126. The turbo charger 130 is powered by the flow of exhaust exiting the exhaust manifold 128 and includes a first turbine 132 in the exhaust stream and a second turbine 134 that pressurizes the intake air provided to the air intake manifold 126. The first and second turbines 132, 134 are coupled together by a shaft 136 such that torque provided from the first turbine 132 is transferred through the shaft 136 to the second turbine 134. A charge air cooler 138 cools the intake air provided to the air intake manifold 126. Exhaust gas recirculation is also provided to the air intake manifold 126. For example, an exhaust gas recirculation line 140 directs exhaust gas from the exhaust side of the engine 116 to an exhaust gas recirculation mixer 143 where the recirculated exhaust gas mixes with the intake air from the charge air cooler 138 prior to being directed into the air intake manifold 126.

In the depicted example, the Rankine cycle system 100 is configured to recapture wasted energy from the engine 116 by drawing waste heat from the exhaust gas recirculation line 140. In this way, the organic Rankine cycle system 100 draws heat from the exhaust gas flowing through the exhaust gas recirculation line 140, thereby cooling the exhaust gas recirculated through the exhaust gas recirculation line 140 prior to the exhaust gas reaching the exhaust gas recirculation mixer 143. In other examples, waste heat can be accessed from other locations (e.g., the main exhaust line) and used to drive the Rankine cycle system 100.

As depicted at FIG. 1, the heating zone 106 of the organic Rankine cycle system 100 includes at least one heat exchanger for drawing heat from the exhaust gas recirculation line 140 thereby cooling the recirculated exhaust gas. As specifically depicted in FIG. 1, the heating zone 106 includes a first stage heat exchanger 150 and a second stage heat exchanger 152. The heat exchangers 150, 152 transfer heat from the exhaust gas recirculation line 140 to the working fluid of the Rankine cycle circuit 102 as the working fluid passes through the heating zone 106 thereby heating and evaporating the working fluid. In certain examples, the working fluid is super-heated. In other examples, the working fluid is not super-heated.

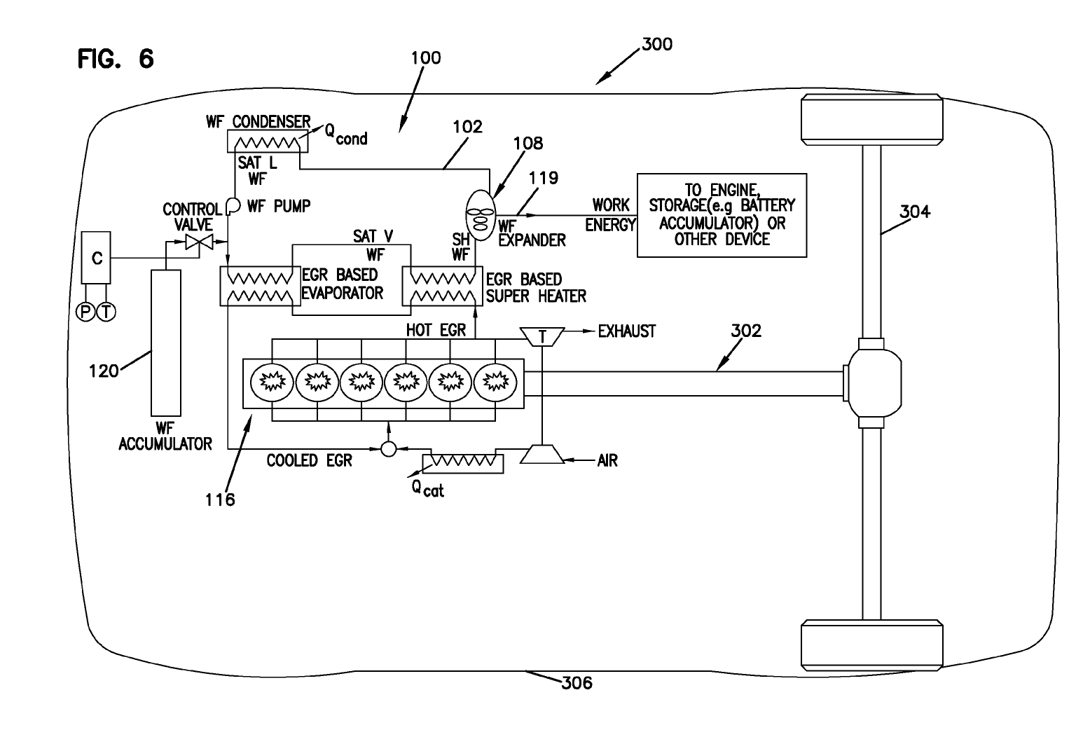

It will be appreciated that the engine 116 can be used to power a vehicle 300 (see FIG. 6). The vehicle 300 can include a torque transfer arrangement 302 (e.g., a drive train, drive shaft, transmission, differential, etc.) for transferring torque from the engine crankshaft to one or more axles 304 of the vehicle 300. The axles can be coupled to wheels, tracks or other structures adapted to contact the ground. In such examples, the organic Rankine cycle system 100 and the engine 116 are carried with a vehicle chassis/frame 306 (shown schematically). In alternative examples, other types of prime movers such as fuel cells or spark ignition engines can be used. Similar to the engine 116 described above, fuel cells or spark ignition engines can be used to power vehicles and organic Rankine cycle systems in accordance with the principles of the present disclosure can be incorporated as part of the vehicles.

### Mechanical Energy Extraction/Recovery Device

As described above, the organic Rankine cycle system 100 of FIG. 1 includes a mechanical energy extraction zone 108 including at least one mechanical device (e.g., a reaction turbine, a piston engine, a scroll expander, a screw-type expander, a Roots expanders, etc.) capable of outputting mechanical energy from the Rankine cycle circuit 102. In certain examples, the mechanical device relies upon the kinetic energy, temperature/heat and pressure of the working fluid to rotate an output shaft 119 (see FIG. 1). Where the mechanical device is used in an expansion application, such as with a Rankine cycle, energy is extracted from the working fluid via fluid expansion. In such instances, the mechanical device may be referred to as an expander or expansion device. However, it is to be understood that the mechanical device is not limited to applications where a working fluid is expanded across the device. In certain examples, the mechanical device includes one or more rotary elements (e.g., turbines, blades, rotors, etc.) that are rotated by the working fluid of the Rankine cycle so as to drive rotation of the output shaft of the mechanical device. In certain examples, the output shaft can be coupled to an alternator used to generate electricity, which can be used to power active components or to charge a battery suitable for providing electrical power on demand. In other examples, the output shaft can be coupled to a hydraulic pump used to generate hydraulic pressure, used to power active hydraulic components, or used to charge a hydraulic accumulator (e.g. accumulator 120) suitable for providing hydraulic pressure on demand, in still other examples, the output shaft can be mechanically coupled (e.g., by gears, belts, chains, or other structures) to other active components or back to a prime mover that is the source of waste heat for the Rankine cycle system.

In one example, the mechanical device used at the mechanical energy extracting zone 108 can include a Roots-style rotary device referred to herein as a Roots-style expander because the pressure at the inlet side of the device is greater than the pressure at the outlet side of the device. The pressure drop between the inlet and outlet drives rotation within the device. Typically, except for decompression related to fluid leakage and device inefficiencies, expansion/decompression does not occur within the device itself, but instead occurs as the working fluid exits the device at the outlet. The device can be referred to as a volumetric device since the device has a fixed displacement for each rotation of a rotor within the device.

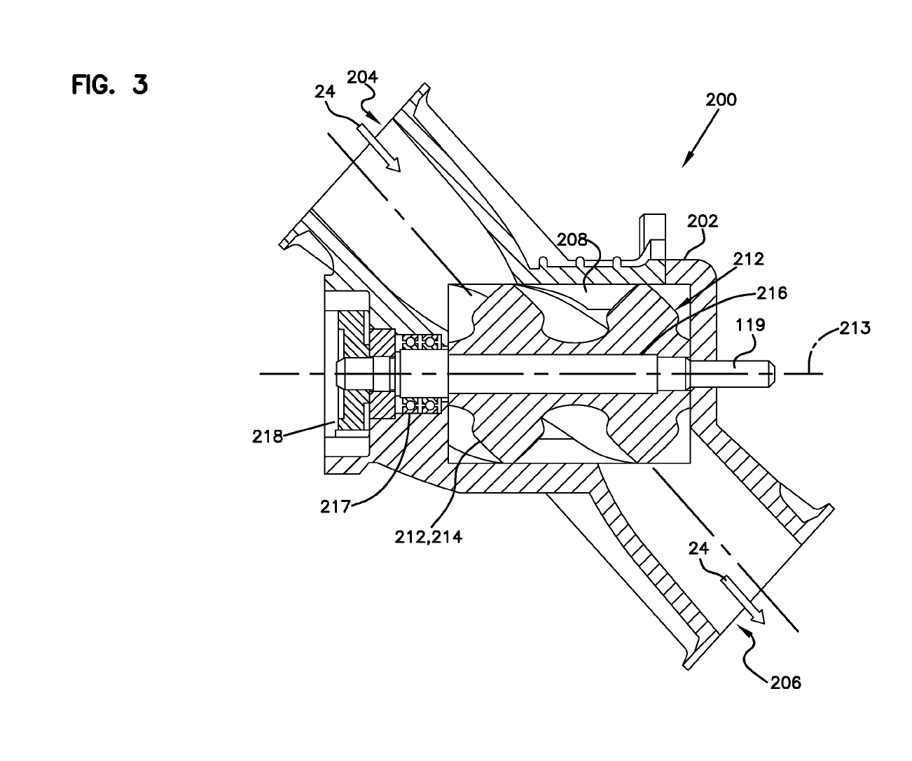

FIGS. 3-5 depict a Roots-style expander 200 suitable for use at the mechanical energy extraction zone 108 of the Rankine cycle system 100. The expander 200 includes a housing 202 having an inlet 204 and an outlet 206. In use, the inlet 204 is in fluid communication with the heating zone 106 of the Rankine cycle system 100 and the outlet 206 is in fluid communication with the condensing zone 104 of the Rankine cycle system 100.

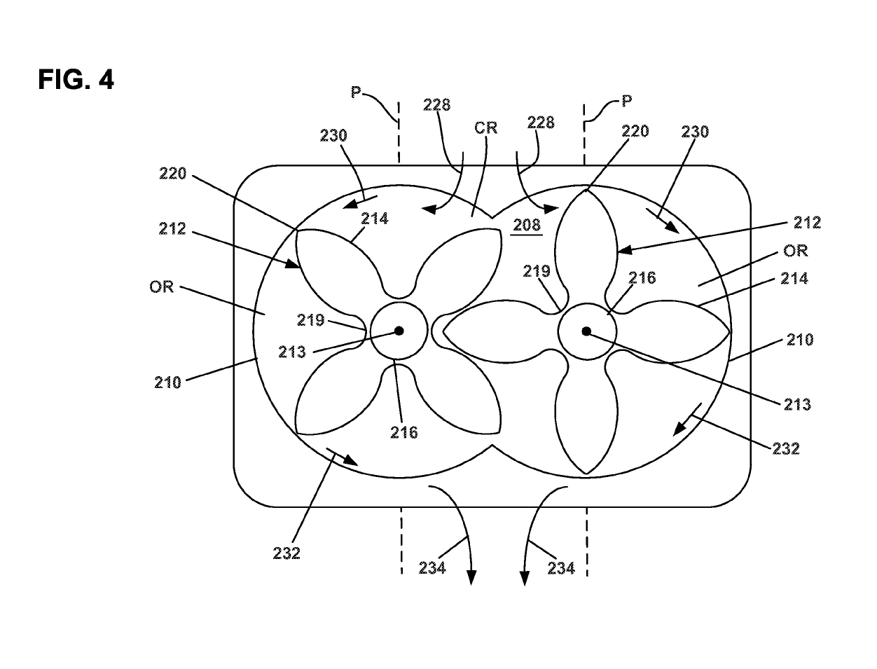

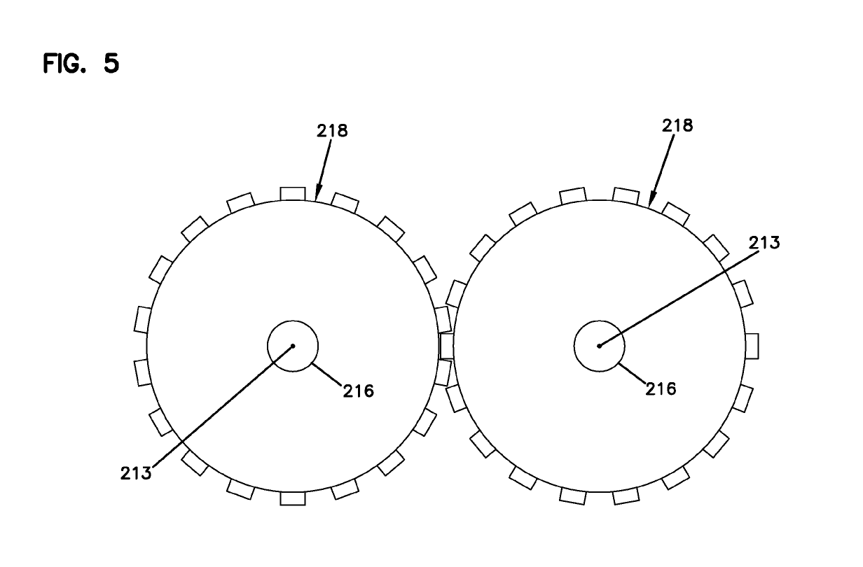

The expander housing 202 defines internal cavity 208 that provides fluid communication between the inlet 204 and the outlet 206. The internal cavity 208 is formed by first and second parallel rotor bores 210 (see FIG. 4) defined by cylindrical bore-defining surfaces 222. The expander 200 also includes first and second rotors 212 respectively mounted in the first and second rotor bores 210. Each of the rotors 212 includes a plurality of lobes 214 mounted on a shaft 216. The shafts 216 are parallel to one another and are rotatably mounted relative to the expander housing 202 by bearings 217 (see FIG. 3). The shafts 216 are free to rotate relative to the housing 202 about parallel axes of rotation 213. The lobes 214 of the first and second rotors 212 intermesh/interleave with one another. Intermeshing timing gears 218 (see FIG. 5) are provided on the shafts 216 so as to synchronize the rotation of the first and second rotors 212, such that the lobes 214 of the first and second rotors 212 do not contact one another in use. In certain examples, the lobes 214 can be twisted or helically disposed along the lengths of the shafts 216. The rotors 212 define fluid transfer volumes 219 between the lobes 214. The lobes 214 can include outer tips 220 that pass in close proximity to the bore-defining surfaces 222 of the housing 202 as the rotors 212 rotate about their respective axes 213. In certain embodiments, the outer tips 220 do not contact the bore-defining surfaces 222.

In use of the expander 200, working fluid (e.g., vaporized working fluid or two-phase working fluid) from the heating zone 106 enters the expander housing 202 through the inlet 204. Upon passing through the inlet 204, the vaporized working fluid enters one of the fluid transfer volumes 219 defined between the lobes 214 of one of the rotors 212. The pressure differential across the expander 200 causes the working fluid to turn the rotor 212 about its axis of rotation 213 such that the fluid transfer volume 219 containing the vaporized working fluid moves circumferentially around the bore-defining surface 222 from the inlet 204 to the outlet 206. As the rotors 212 are rotated by the working fluid, mechanical energy is transferred out from the expander 200 through the output shaft 119 which coincides with one of the shafts 216 (see FIG. 3).

It will be appreciated that working fluid from the inlet 204 enters the internal cavity 208 of the housing 202 (see arrows 228) at a central region CR of the internal cavity 208 that is between parallel planes P that include the axes 213 and that extend between inlet and outlet sides of the expander housing 202 (see FIG. 4). The working fluid from the inlet 204 enters fluid transfer volumes 219 of the rotors 212 at the central region CR and causes the rotors 212 to rotate in opposite directions about their respective axes 213. The rotors 212 are rotated about their respective axes 213 such that the fluid transfer volumes 219 containing the working fluid move away from the central region CR along their respective circumferential bore-defining surface 222 of the housing 202 to outer regions OR (i.e., regions outside the planes P) of the internal cavity 208 as indicated by arrows 230. The rotors 212 continue to rotate about their respective axes 213 thereby moving the fluid transfer volumes 219 from the outer regions OR back to the central region CR adjacent the outlet 206 as indicated by arrows 232. The working fluid from the fluid transfer volumes exits the expander housing 202 through the outlet 206 as indicated by arrows 234.

### Rankine Cycle Operation

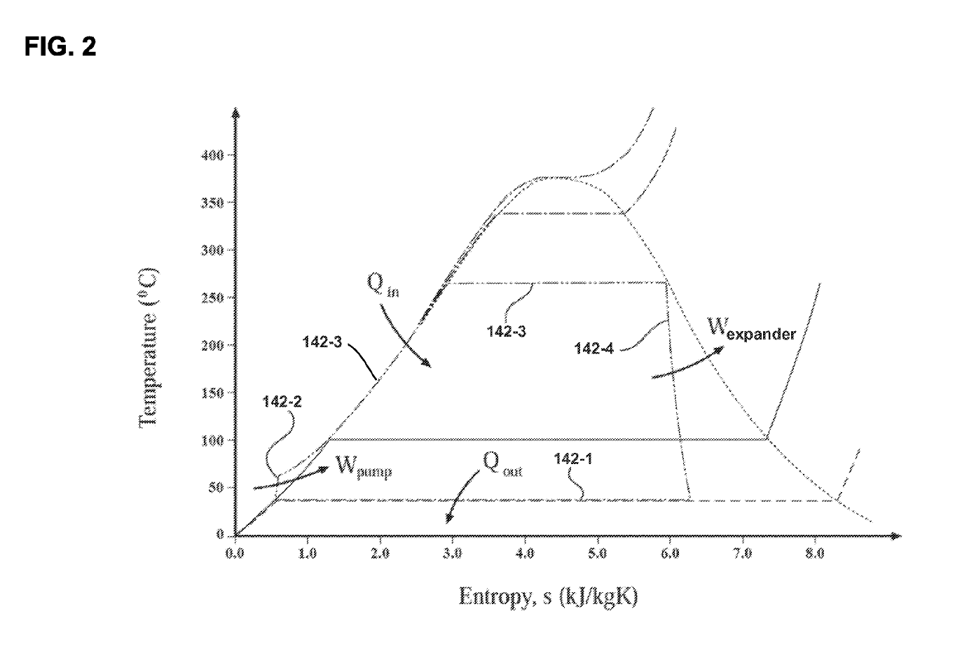

FIG. 2 shows a diagram depicting a representative Rankine cycle applicable to the system 100, as described with respect to FIG. 1. The diagram depicts different stages of the Rankine cycle showing temperature in Celsius plotted against entropy “S”, wherein entropy is defined as energy in kilojoules divided by temperature in Kelvin and further divided by a kilogram of mass (kJ/kg*K). The Rankine cycle shown in FIG. 2 is specifically a closed-loop organic Rankine cycle (ORC) that may use an organic, high molecular mass working fluid, with a liquid-vapor phase change, or boiling point, occurring at a lower temperature than the water-steam phase change of the classical Rankine cycle. Accordingly, in the system 100, the working fluid may be a solvent, such as ethanol, n-pentane or toluene.

In the diagram of FIG. 2, the term “Q” represents the heat flow to or from the system 100, and is typically expressed in energy per unit time. The term “W” represents mechanical power consumed by or provided to the system 100, and is also typically expressed in energy per unit time. As may be additionally seen from FIG. 2, there are four distinct processes or stages 142-1, 142-2, 142-3, and 142-4 in the ORC. During stage 142-1, the working fluid, in the form of a wet vapor, enters and passes through the condensing zone 104 in which the working fluid 24 is condensed at a constant temperature to become a saturated liquid. Following stage 142-1, the working fluid is pumped from low to high pressure by the pump 110 during the stage 142-2. During stage 142-2, the working fluid 24 is in a liquid state.

During stage 142-3, the pressurized working fluid enters and passes through the first stage heat exchanger 150 where it is heated at constant pressure by an external heat source to become a two-phase fluid (i.e., liquid together with vapor). The two-phase fluid enters and passes through a second stage heat exchanger 152 where it is further heated and vaporized. During stage 142-4, the working fluid, in the form of a fully vaporized fluid or a two-phase fluid, passes through the mechanical energy extracting zone 108, thereby generating useful work or power. The working fluid may expand at the outlet of the mechanical energy extracting zone 108 thereby decreasing the temperature and pressure of the working fluid such that some additional condensation of the working fluid may occur. Following stage 142-4, the working fluid is returned to the condensing zone 104, at which point the cycle completes and will typically restart at stage 142-1.

### Accumulator —General

The accumulator 120 (i.e., pressure storage device) is adapted to store potential energy in the form of pressurized working fluid for later use when needed to satisfy pressure demand requirements by the system. In one example, the accumulator 120 is a hydraulic accumulator including a hydraulic pressure storage reservoir/vessel. The storage reservoir is adapted to contain an incompressible hydraulic fluid (e.g., the condensed working fluid) and includes an external pressure source (e.g., a spring, raised weight or compressed gas) that maintains the hydraulic fluid under pressure within the storage reservoir. In general, the accumulator 120 can be charged with pressurized working fluid from the high pressure side of the pump 110 when the system 100 is operating under normal working conditions. Subsequently, the accumulator 120 can be configured to release some or all of stored volume of pressurized working fluid to the Rankine cycle circuit 102 on demand to maintain pressure within the circuit 102 above a predetermined level. In one example, the pressurized working fluid can be released when the Rankine cycle circuit 102 is de-activated by turning off the pump 110.

Referring again to FIG. 1, the flow line 122 connects the accumulator 120 to the closed-loop hydraulic circuit 102 at a location between the fluid pump 110 and the first stage heat exchanger 150. A controller 160 can be used to actuate the control valve 124 between open and closed positions. In various aspects, the system 100 may further include one or more pressure sensors 162 and/or temperature sensors 164 with which the controller 160 interfaces. The pressure and temperature sensors 162, 164 can be adapted to provide signals corresponding to the pressure and temperature at various locations in the closed circuit 102 of the Rankine cycle thereby allowing the controller 160 to monitor the pressure and temperature in the circuit 102 of the Rankine cycle system 100. In one example, the sensors 162, 164 are located to characterize the conditions of the working fluid at the inlet 204 of the expander 108 while in another example the sensors 162, 164 are located to sense the conditions in the circuit 102 at the flow line 122.

Pressure and/or temperature sensors 163, 164 can also be used to allow the controller 160 to monitor the pressure and temperature within the accumulator 120. During operation of the system 100 with the pump 110 running, the controller 160 can continuously monitor the pressure in the circuit 102 and the pressure in the accumulator 120. In the event the pressure in the circuit 102 at the flow line 122 is above a predetermined circuit pressure level and the pressure in the accumulator 120 is below a predetermined accumulator pressure level that is less than the predetermined circuit pressure level, the controller 160 can open the valve 124 thereby allowing the accumulator 120 to be charged with pressure/fluid from the circuit 102/pump 110. This event would 2.0 typically take place when the engine 116 is running and the pump 110 of the system 100 is operating so that the Rankine cycle system can effectively recapture waste heat from engine 116. The controller 160 can close the valve 124 once the accumulator 120 reaches a charged pressure level, which may correspond to the predetermined circuit pressure level.

When the engine 116 is turned off, waste heat is no longer available to drive the Rankine cycle system. In this condition, the controller 160 can detect that the engine 116 has been turned off and can terminate operation of the pump 110. The lack of waste heat causes the working fluid in the circuit 102 to cool. As the working fluid in the circuit 102 cools, the controller 160 can monitor the temperature and/or pressure in the circuit 102. In the event the pressure nears negative pressure levels as compared to atmospheric pressure, the controller 160 can open the valve 124 to direct fluid and pressure from the accumulator 120, to the circuit 102 thereby minimizing or preventing a vacuum condition from developing in the circuit 102. In some embodiments, the valve 124 can be opened by the controller 160 when: the sensed temperature of the working fluid falls below a predetermined setpoint; the sensed pressure of the working fluid falls below a predetermined setpoint; the sensed temperature of the ambient temperature falls below a predetermined setpoint; and/or working fluid conditions fall below a setpoint that is a function of both the working fluid temperature and pressure.

From the foregoing detailed description, it will be evident that modifications and variations can be made without departing from the spirit and scope of the disclosure.

1. A post engine shutdown management system for a Rankine cycle system comprising:
a prime mover;
a Rankine cycle circuit in which working fluid is cycled through a condensing zone, a heating zone, and a mechanical energy extraction zone the Rankine cycle circuit being configured to capture waste heat generated by the prime mover;
a hydraulic accumulator for storing pressurized working fluid from the Rankine cycle circuit when a pressure of the working fluid within the Rankine cycle circuit is above a first predetermined condition, and for releasing pressurized working fluid to the Rankine cycle circuit when the power plant is shut down and when the working fluid within the Rankine cycle circuit is below a second second predetermined condition to minimize or prevent a vacuum pressure condition from developing in the Rankine cycle circuit.

2. The post engine shutdown management system for a Rankine cycle system of claim 1, wherein the first predetermined condition is a first working fluid pressure and the second predetermined condition is a second working fluid pressure less than the first working fluid pressure.

3. The post engine shutdown management system for a Rankine cycle system of claim 1, further comprising a hydraulic pump for moving the working fluid through the Rankine cycle circuit, the hydraulic pump having a low pressure side in fluid communication with the condensing zone and a high pressure side in fluid communication with the heating zone.

4. The post engine shutdown management system for a Rankine cycle system of claim 3, wherein the Rankine cycle circuit is an organic Rankine cycle circuit.

5. The post engine shutdown management system for a Rankine cycle system of claim 3, further comprising a flow line that fluidly connects the hydraulic accumulator to the Rankine cycle circuit at a location between the high pressure side of the hydraulic pump and the heating zone.

6. The post engine shutdown management system for a Rankine cycle system of claim 5, further comprising a flow control valve positioned along the flow line for selectively opening and closing fluid communication between the hydraulic accumulator and the Rankine cycle circuit.

7. The post engine shutdown management system for a Rankine cycle system of claim 6, wherein the hydraulic accumulator is charged with pressurized working fluid from the high pressure side of the hydraulic pump.

8. The post engine shutdown management system for a Rankine cycle system of claim 1, wherein working fluid is heated at the heating zone by waste heat from the prime mover.

9. The post engine shutdown management system for a Rankine cycle system of claim 8, wherein the prime mover is selected from the group consisting of an internal combustion engine and a fuel cell.

10. The post engine shutdown management system for a Rankine cycle system of claim 8, wherein the prime mover is a diesel engine and wherein the waste heat is recaptured from an exhaust gas recirculation line of the diesel engine.

11. The post engine shutdown management system for a Rankine cycle system of claim 1, wherein the mechanical extraction zone includes a fixed displacement expander.

12. A The post engine shutdown management system for a Rankine cycle system of claim 1, wherein comprising:
the working fluid is an organic working fluid;
the condensing zone includes a condenser for condensing the organic working fluid;
the heating zone includes a heat exchanger for heating the organic working fluid;
the mechanical energy extraction zone includes a fixed displacement mechanical expansion device for extracting energy from the organic working fluid, the mechanical expansion device including first and second interleaved rotors each having a plurality of lobes mounted on a shaft, the mechanical expansion device including intermeshing timing gears that coordinate rotation of the rotors and prevent the lobes of the first and second interleaved rotors from contacting each other, the mechanical expansion device including a housing having an inlet, an outlet, and an interior region that provides fluid communication between the inlet and the outlet, the interior region including first and second rotor bores in which the first and second rotors are respectively positioned, the first and second rotors defining fluid transfer volumes between the lobes that transfer working fluid circumferentially about the bores from the inlet to the outlet, and at least one of the shafts defining an output shaft; and
the Rankine cycle circuit further includes a pump positioned between the condenser and the heat exchanger for pumping condensed organic working fluid received from the condenser to the heat exchanger, wherein heated organic working fluid flows from the heat exchanger to the inlet of the mechanical expansion device, and wherein expanded working fluid flows from the outlet of the mechanical expansion device to the condenser
wherein the post engine shutdown management system further includes a flow control valve for selectively opening and closing fluid communication between the hydraulic accumulator and a Rankine cycle circuit of the Rankine cycle system and wherein the hydraulic accumulator is charged with pressurized working fluid from a high pressure side of the hydraulic pump.

13. (canceled)

14. (canceled)

15. (canceled)

16. A vehicle comprising:
a chassis;
a prime mover carried by the chassis for powering the vehicle;
a Rankine cycle circuit carried by the chassis in which working fluid is cycled through a condensing zone, a heating zone, and a mechanical energy extraction zone, the Rankine cycle circuit being configured to capture waste heat generated by the prime mover;
a post engine shutdown management system including a hydraulic accumulator carried by the chassis for storing pressurized working fluid from the Rankine cycle circuit when a pressure of the working fluid within the Rankine cycle circuit is above a first pressure level, and for releasing pressurized working fluid to the Rankine cycle circuit when the working fluid within the Rankine cycle circuit is below a second pressure level, wherein the hydraulic accumulator minimizes or prevents a vacuum pressure condition from developing in the Rankine cycle circuit.

17. (canceled)

18. The vehicle of claim 16, further comprising a hydraulic pump for moving the working fluid through the Rankine cycle circuit, the hydraulic pump having a low pressure side in fluid communication with the condensing zone and a high pressure side in fluid communication with the heating zone, and wherein the Rankine cycle circuit is an organic Rankine cycle circuit.

19. The vehicle of claim 18, further comprising a flow line that fluidly connects the hydraulic accumulator to the Rankine cycle circuit at a location between the high pressure side of the hydraulic pump and the heating zone.

20. The vehicle of claim 19, further comprising a flow control valve positioned along the flow line for selectively opening and closing fluid communication between the hydraulic accumulator and the Rankine cycle circuit.

21. The vehicle of claim 16, wherein the prime mover is a diesel engine and wherein the waste heat is recaptured from an exhaust gas recirculation line of the diesel engine.

22. A method for managing a working fluid pressure condition in a Rankine cycle system associated with a power plant in a shutdown condition, the method comprising:
providing an accumulator in selective fluid communication with the Rankine cycle system;
providing a control valve to isolate the accumulator from the Rankine cycle system working fluid;
storing pressurized working fluid in the accumulator while the power plant is in an operative state by placing the control valve in an open condition;
isolating the accumulator from the Rankine cycle system by closing the control valve;
opening the control valve to place the accumulator in fluid communication with the Rankine cycle system by opening the control valve when the prime mover is in a shutdown condition and when a minimum threshold condition is reached to minimize or prevent a vacuum pressure condition from developing in the Rankine cycle circuit.

23. The method for managing a working fluid pressure condition in a Rankine cycle system of claim 22, wherein the minimum threshold condition is a pressure of the Rankine cycle working fluid.

24. The method for managing a working fluid pressure condition in a Rankine cycle system of claim 22, wherein the minimum threshold condition is an ambient air temperature.
